(19) United States
(12) Patent Application Publication
(10) Pub. No.: US 2013/0331117 A1
(43) Pub. Date: Dec. 12, 2013

(54) METHOD AND APPARATUS FOR WHITE SPACE DATABASE DISCOVERY

(71) Applicants: Michael Probasco, Bedford, TX (US); Basavaraj Patil, Coppell, TX (US)

(72) Inventors: Michael Probasco, Bedford, TX (US); Basavaraj Patil, Coppell, TX (US)

(73) Assignee: NOKIA CORPORATION, Espoo (FI)

(21) Appl. No.: 13/490,187

(22) Filed: Jun. 6, 2012

(51) Int. Cl. H04W 24/00

(52) U.S. Cl. 455/456.1

(57) ABSTRACT

Methods, apparatuses, and computer program products herein enable a communication device to determine contact information for at least one white space database. One example method may include causing location indication information to be transmitted to a white space database discovery server. The method may further include receiving address information for one or more white space databases from the white space database discovery server based at least in part on the location indication information. The method may further include causing a connection with at least one of the one or more white space databases based on the address information.

### TECHNOLOGICAL FIELD

Embodiments of the present invention relate generally to communications technology and, more particularly, relate to a method, apparatus, and computer program product for facilitating wireless communications over a regulated frequency band.

### BACKGROUND

Many governments around the world are creating regulations that allow a communication device having a cognitive radio (CR) to operate in certain frequency bands (for example, unlicensed, license exempt or white space frequency bands). For example, the Federal Communications Commission (FCC) in the United States has already passed such regulations, the Office of Communications (OFCOM) in the UK has announced it will develop such regulations, the European Conference of Postal and Telecommunications Administrations (CEPT)/Electronic Communications Committee (ECC) in Europe is outlining requirements for regulations.

To access the white space frequency bands, each regulatory body generally may request and/or require that the communication device perform a lookup into a white space database before it can transmit. This lookup is used to prevent transmissions from a communication device, for example, from interfering with other transmissions on a white space frequency band, such as but not limited to, television broadcasts.

Each regulatory body may write slightly different regulations defining how a communication device and a white space database are to interoperate. While the concept remains generally the same, each country or region may have slightly different variations in precisely what information is exchanged between the communication device and a white space spectrum database. For example, in the United States the FCC has authorized ten different white space database operators, and a communication device may interact with any authorized white space database. Whereas in the UK, while there while there will be multiple databases, OFCOM will host a website that lists the white space databases and therefore the communication device will be required to contact this website to obtain a list of the authorized white space databases before contacting a particular white space database.

The Internet Engineering Task Force (IETF) Protocol to Access White Space (PAWS) database working group is also defining a standards track protocol which can be used globally by communication devices to contact a white space spectrum database. This protocol may satisfy the regulations of each country or region. While the protocol enables a common language for communication between a communication device and a white space database, each region may have a separate dialect of this protocol in order to properly implement the variations in requirements. One example is that the regulations in the United States do not include a maximum transmit power for a given radio frequency; while the preliminary requirements in Europe do include a maximum transmit power for each frequency. Even with the variance between regulatory requirements of different countries, current communications devices are expected to operate in multiple regulatory environments.

### BRIEF SUMMARY

Methods, apparatuses, and computer program products are described herein that are configured to enable a communication device to determine an identifier and contact information for one or more white space databases that are configured to provide operating instructions for the use of a white space frequency band in a regulated area. The communication device may be configured to cause a transmission of location indication information (for example, the communication device's current location or information that may be used to determine the communication device's current location) to a white space database discovery server. Based at least in part on the received location indication information, the white space database discovery server may then provide, to the communication device, address information such as an identifier (for example, a uniform resource locator, a fully qualified domain name or the like) and a contact method (for example, direct, indirect or the like) for accessing one or more white space databases that may enable the communication device to operate on a white space frequency band. The communication device may then request a channel from the white space database using the received identifier and contact method.

In some example embodiments, a method is provided that comprises causing location indication information to be transmitted to a white space database discovery server. The method of this embodiment may also include receiving address information for one or more white space databases from the white space database discovery server based at least in part on the location indication information. The method of this embodiment may also include causing a connection with at least one of the one or more white space databases based on the address information.

In further example embodiments, an apparatus is provided that includes at least one processor and at least one memory including computer program code with the at least one memory and the computer program code being configured, with the at least one processor, to cause the apparatus to at least cause location indication information to be transmitted to a white space database discovery server. The at least one memory and computer program code may also be configured to, with the at least one processor, cause the apparatus to receive address information for one or more white space databases from the white space database discovery server based at least in part on the location indication information. The at least one memory and computer program code may also be configured to, with the at least one processor, cause the apparatus to cause a connection with at least one of the one or more white space databases based on the address information.

In yet further example embodiments, a computer program product may be provided that includes at least one non-transitory computer-readable storage medium having computer-readable program instructions stored therein with the computer-readable program instructions including program instructions configured to cause location indication information to be transmitted to a white space database discovery server. The computer-readable program instructions may also include program instructions configured to receive address information for one or more white space databases from the white space database discovery server based at least in part on the location indication information. The computer-readable program instructions may also include program instructions configured to cause a connection with at least one of the one or more white space databases based on the address information.

In yet further example embodiments, an apparatus is provided that includes means for causing location indication information to be transmitted to a white space database discovery server. The apparatus of this embodiment may also include means for receiving address information for one or more white space databases from the white space database discovery server based at least in part on the location indication information. The apparatus of this embodiment may also include means for causing a connection with at least one of the one or more white space databases based on the address information.

In some example embodiments, a method is provided that comprises receiving location indication information from a communication device. The method of this embodiment may also include determining one or more white space databases for use by the communication device based on the location information. The method of this embodiment may also include causing address information for one or more white space databases to be transmitted to the communication device.

In further example embodiments, an apparatus is provided that includes at least one processor and at least one memory including computer program code with the at least one memory and the computer program code being configured, with the at least one processor, to cause the apparatus to at least receive location indication information from a communication device. The at least one memory and computer program code may also be configured to, with the at least one processor, cause the apparatus to determine one or more white space databases for use by the communication device based on the location information. The at least one memory and computer program code may also be configured to, with the at least one processor, cause the apparatus to cause address information for one or more white space databases to be transmitted to the communication device.

In yet further example embodiments, a computer program product may be provided that includes at least one non-transitory computer-readable storage medium having computer-readable program instructions stored therein with the computer-readable program instructions including program instructions configured to receive location indication information from a communication device. The computer-readable program instructions may also include program instructions configured to determine one or more white space databases for use by the communication device based on the location information. The computer-readable program instructions may also include program instructions configured to cause address information for one or more white space databases to be transmitted to the communication device.

In yet further example embodiments, an apparatus is provided that includes means for receiving location indication information from a communication device. The apparatus of this embodiment may also include means for determining one or more white space databases for use by the communication device based on the location information. The apparatus of this embodiment may also include means for causing address information for one or more white space databases to be transmitted to the communication device.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a schematic representation of a system having a communication device that may enable white space database discovery and that may benefit from example embodiments of the present invention;

FIG. 2 illustrates an example block diagram of an example communication device configured to perform database discovery according to some example embodiments of the present invention;

FIG. 3 is an example schematic block diagram of an example mobile terminal according to some example embodiments of the present invention; and

FIG. 4 illustrates a block diagram of an example white space database discovery server or a white space database according to some example embodiments of the current invention;

FIGS. 5-11 illustrate signal flow diagrams according to some example embodiments of the current invention;

FIG. 12 illustrates a flowchart according to an example method configured to be executed by a communication device according to some example embodiments of the current invention; and

FIG. 13 illustrates a flowchart according to an example method configured to be executed by a white space database discovery server according to some example embodiments of the current invention.

### DETAILED DESCRIPTION

Example embodiments will now be described more fully hereinafter with reference to the accompanying drawings, in which some, but not all embodiments are shown. Indeed, the embodiments may take many different forms and should not be construed as limited to the embodiments set forth herein; rather, these embodiments are provided so that this disclosure will satisfy applicable legal requirements. Like reference numerals refer to like elements throughout. The terms “data,” “content,” “information,” and similar terms may be used interchangeably, according to some example embodiments, to refer to data capable of being transmitted, received, operated on, and/or stored. Moreover, the term “exemplary”, as may be used herein, is not provided to convey any qualitative assessment, but instead merely to convey an illustration of an example. Thus, use of any such terms should not be taken to limit the spirit and scope of embodiments of the present invention.

As used herein, the term “circuitry” refers to all of the following: (a) hardware-only circuit implementations (such as implementations in only analog and/or digital circuitry); (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions); and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in a server, a cellular network device, or other network device.

In some examples, a communications device may be configured to operate in regulated or white space frequency bands in a manner that is similar to broadband wireless access, for example such as how a communications device may be configured to operate in conjunction with a wireless fidelity hotspot. As such a communications device having a CR may be able to connect to a regulated or white space frequency band hotspot, such that the communications device would have access to a communications network, the Internet or the like.

In some examples, a communication device may have self-locating capabilities (for example, such as via a global positioning system (GPS)), however the communication device may not know or may have old information as to which white space databases are available to query based on its current location. The communications device may also need to determine whether to contact a white space database directly (for example, as in the US) or contact a white space database indirectly using a “listing service” or regional server first (for example, as in the UK). Further, the communication device may need to obtain white space database information from a reliable source to ensure that the communication device contacts an authenticated server.

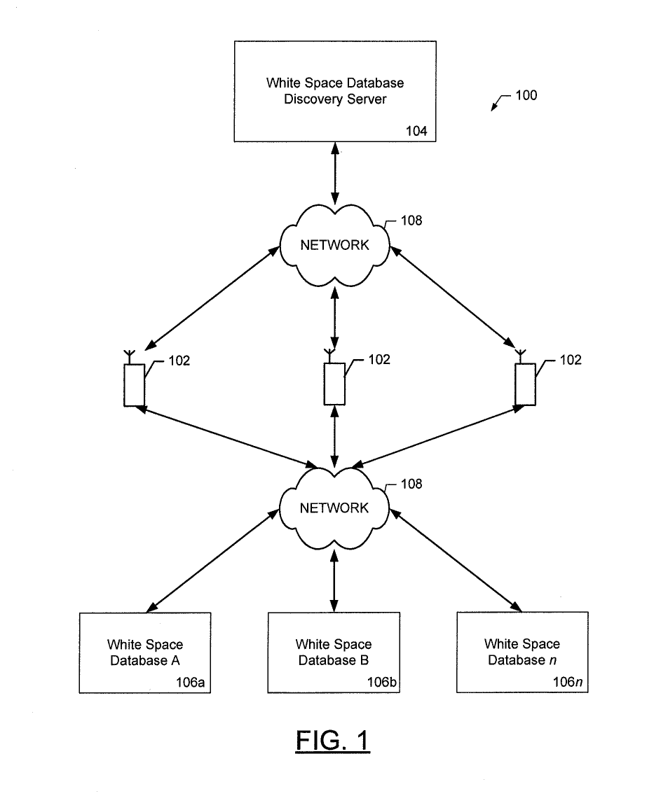

Referring now to FIG. 1, FIG. 1 is a schematic representation of a system having a communication device that may enable white space database discovery and that may benefit from example embodiments of the present invention. It will be appreciated that the system 100 as well as the illustrations in other figures are each provided as an example of some embodiments and should not be construed to narrow the scope or spirit of the disclosure in any way. In this regard, the scope of the disclosure encompasses many potential embodiments in addition to those illustrated and described herein. As such, while FIG. 1 illustrates one example configuration of a system for providing white space database access information; numerous other configurations may also be used to implement embodiments of the present invention.

The system 100 may include one or more communication devices 102, one or more white space database discovery servers 104 and one or more white space databases, such as white space database A 106a, white space database B 106b and white space database n 106n, which may also be referred to collectively as white space database 106 herein. In some example embodiments, white space database A 106a, white space database B 106b and white space database n 106n are each are configured to provide information for operating on regulated or whitespace frequency bands in different geographic regions. The system 100 may further comprise a network 108. The network 108 may comprise one or more wireline networks, one or more wireless networks, or some combination thereof. The network 108 may, for example, comprise a serving network (for example, a serving cellular network) for one or more communication devices 102. The network 108 may comprise, in certain embodiments, one or more of the communication devices 102, white space database discovery servers 104 and/or white space databases 106a-n themselves. According to example embodiments, the network 108 may comprise the Internet. In various embodiments, the network 108 may comprise a wired access link connecting one or more communication devices 102 to the rest of the network 108 using, for example, Digital Subscriber Line (DSL) technology. In some embodiments, the network 108 may comprise a public land mobile network (for example, a cellular network), such as may be implemented by a network operator (for example, a cellular access provider). The network 108 may operate in accordance with universal terrestrial radio access network (UTRAN) standards, evolved UTRAN (E-UTRAN) standards, current and future implementations of 3GPP LTE (also referred to as LTE-A) standards, current and future implementations of International Telecommunications Union (ITU) International Mobile Telecommunications-Advanced (IMT-A) systems standards, wireless fidelity standards and/or the like. Alternatively or additionally the network may comprise a connection via circuit-switched communication channel as well as packet based communications channels. It will be appreciated, however, that where references herein are made to a network standard and/or terminology particular to a network standard, the references are provided merely by way of example and not by way of limitation.

A communication device 102 may be embodied as any computing device, such as, for example, a desktop computer, laptop computer, mobile terminal, mobile computer, mobile phone, smartphone, mobile communication device, tablet computing device, pad, game device, digital camera/camcorder, audio/video player, television device, radio receiver, digital video recorder, positioning device, wrist watch, portable digital assistant (PDA), fixed transceiver device (for example, attached to traffic lights, energy meters, light bulbs, and/or the like), a chipset, an apparatus comprising a chipset, any combination thereof, and/or the like. Alternatively or additionally, the communications device 102 may take the form of an access point (for example, a macrocell, microcell, picocell, femtocell, closed subscriber group (CSG) cell, base station, base transceiver station (BTS), node B, evolved node B, access point (AP), group owner, mesh station (STA), mesh point, and/or the like).

In some example embodiments, the communications device 102 may be configured to determine at least one authorized white space database, such as white space databases 106a-n, that is configured to provide a communications channel for the communication device's current location. In some example embodiments, white space databases 106a-n may be embodied as a white space database or other data store as defined by a particular region, such as by the FCC, CEPT/ECC, OFCOM or the like. White space databases 106a-n may be configured to provide the communication devices 102 with a list of vacant channels where the communication devices 102 can transmit (if any channels are vacant).

Further and as described according to some example embodiments, the white space database discovery server 104 may take the form of a network element, a data store, a server or the like and is configured to maintain a list of authorized white space databases. In some example embodiments, an FQDN, address or other identifier of the white space database discovery server 104 may be preconfigured in the communication device, provisioned via device management protocols such as open mobile alliance (OMA) device management, accessed via a manufacturer's service or the like.

In order to determine, locate, and/or connect with the at least one authorized white space database, the communications device 102 may provide location indication information (for example, GPS information, latitude/longitude, mobile country code (MCC)/mobile network code (MNC) of the cellular network, service set identification (SSID), base station identifier or the like) via the network 108 to a white space database discovery server 104. The white space database discovery server 104 may be configured to use this location indication information to determine which white space database(s), such as white space databases 106a-n, are authorized to serve the communications device 102 at its current location. The white space database discovery server 104 is configured to provide an identifier (for example, uniform resource locator (URL), fully qualified domain name (FQDN) or the like) and a contact method (direct, indirect, protocol, schema or the like) for the one or more white space databases located in the regulatory region where the communication device is currently located.

Alternatively or additionally, the white space database discovery server 104 may also return information on a geographic coverage area, identification credentials, or schema that specifies what optional messages and information elements the communication device 102 may use when communicating with the white space database. The white space database discovery server 104 may, for example, optimize the white space databases returned such that any services requested by the communications device 102 are provided by the returned white space database. The white space database discovery server 104 may also use a digital signature to introduce assurance that the communication device 102 requests service from an authorized white space database.

The communication device 102 may then be configured to connect with one or more white space databases using the received identifier and contact method. In an instance in which at least one white space database has been discovered, a communications device 102 using the received identifier and contact method, may be configured to determine a schema and/or protocol dialect to communicate with the white space database. White space database protocol discovery is further described with reference to U.S. patent application Ser. No. 13/339,036 filed Dec. 28, 2011, which is hereby incorporated by reference herein.

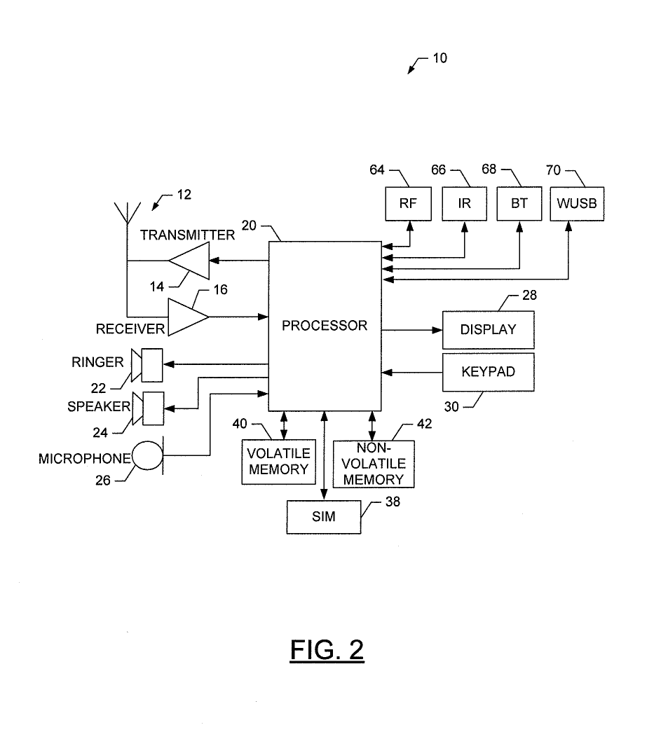

In some example embodiments, a communication device 102 may be embodied as an example mobile terminal, such as that illustrated in FIG. 2. In this regard, FIG. 2 illustrates a block diagram of a mobile terminal 10 representative of one embodiment of a communication device 102. It should be understood, however, that the mobile terminal 10 illustrated and hereinafter described is merely illustrative of one type of computing device (for example, communication device 102) that may implement and/or benefit from various embodiments and, therefore, should not be taken to limit the scope of the disclosure. While several embodiments of the electronic device are illustrated and will be hereinafter described for purposes of example, other types of electronic devices, such as mobile telephones, mobile computers, portable digital assistants (PDAs), pagers, laptop computers, desktop computers, gaming devices, televisions, and other types of electronic systems, may employ various embodiments of the invention.

As shown, the mobile terminal 10 may include an antenna 12 (or multiple antennas 12) in communication with a transmitter 14 and a receiver 16. The mobile terminal 10 may also include a processor 20 configured to provide signals to and receive signals from the transmitter and receiver, respectively. The processor 20 may, for example, be embodied as various means including circuitry, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), or some combination thereof. Accordingly, although illustrated in FIG. 2 as a single processor, in some example embodiments the processor 20 may comprise a plurality of processors. These signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques such as Bluetooth™ (BT), Ultra-wideband (UWB), Institute of Electrical and Electronics Engineers (IEEE) 802.11, 802.16, and/or the like. In addition, these signals may include speech data, user generated data, user requested data, and/or the like. In this regard, the mobile terminal may be capable of operating with one or more air interface standards, communication protocols, modulation types, access types, and/or the like. More particularly, the mobile terminal may be capable of operating in accordance with various mobile communication protocols, Internet Protocol Multimedia Subsystem (IMS) communication protocols (for example, session initiation protocol (SIP)), and/or the like. For example, the mobile terminal may be capable of operating in accordance with 2G wireless communication protocols IS-136 (Time Division Multiple Access (TDMA)), Global System for Mobile communications (GSM), IS-95 (Code Division Multiple Access (CDMA)), and/or the like. Also, for example, the mobile terminal may be capable of operating in accordance with 2.5G wireless communication protocols General Packet Radio Service (GPRS), Enhanced Data GSM Environment (EDGE), and/or the like. Further, for example, the mobile terminal may be capable of operating in accordance with 3G wireless communication protocols such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The mobile terminal may be additionally capable of operating in accordance with 3.9G wireless communication protocols such as LTE or Evolved Universal Terrestrial Radio Access Network (E-UTRAN) and/or the like. Additionally, for example, the mobile terminal may be capable of operating in accordance with fourth-generation (4G) wireless communication protocols such as LTE-A and/or the like as well as similar wireless communication protocols that may be developed in the future. The mobile terminal may be capable in operating with various IEEE and IETF standards, for example IEEE 802.11 standard for wireless fidelity (Wi-Fi) or Worldwide Interoperability for Microwave Access (WiMAX) protocols.

It is understood that the processor 20 may comprise circuitry for implementing audio/video and logic functions of the mobile terminal 10. For example, the processor 20 may comprise a digital signal processor device, a microprocessor device, an analog-to-digital converter, a digital-to-analog converter, and/or the like. Control and signal processing functions of the mobile terminal may be allocated between these devices according to their respective capabilities. Further, the processor may comprise functionality to operate one or more software programs, which may be stored in memory. For example, the processor 20 may be capable of operating a connectivity program, such as a web browser. The connectivity program may allow the mobile terminal 10 to transmit and receive web content, such as location-based content, according to a protocol, such as Wireless Application Protocol (WAP), hypertext transfer protocol (HTTP), and/or the like. The mobile terminal 10 may be capable of using Transmission Control Protocol/Internet Protocol (TCP/IP) to transmit and receive web content across the internet or other networks.

The mobile terminal 10 may also comprise a user interface including, for example, an earphone or speaker 24, a ringer 22, a microphone 26, a display 28, a user input interface, and/or the like, which may be operationally coupled to the processor 20. In this regard, the processor 20 may comprise user interface circuitry configured to control at least some functions of one or more elements of the user interface, such as, for example, the speaker 24, the ringer 22, the microphone 26, the display 28, and/or the like. The processor 20 and/or user interface circuitry comprising the processor 20 may be configured to control one or more functions of one or more elements of the user interface through computer program instructions (for example, software and/or firmware) stored on a memory accessible to the processor 20 (for example, volatile memory 40, non-volatile memory 42, and/or the like). The mobile terminal may comprise a battery for powering various circuits related to the mobile terminal, for example, a circuit to provide mechanical vibration as a detectable output. The user input interface may comprise devices allowing the mobile terminal to receive data, such as a keypad 30, a touch display, a trackpad, and/or other input device. In embodiments including a keypad, the keypad may comprise numeric (0-9) and related keys (#, *), and/or other keys for operating the mobile terminal.

As shown in FIG. 2, the mobile terminal 10 may also include one or more means for sharing and/or obtaining data. For example, the mobile terminal may comprise a short-range radio frequency (RF) transceiver and/or interrogator 64 so data may be shared with and/or obtained from electronic devices in accordance with RF techniques. The mobile terminal may comprise other short-range transceivers, such as, for example, an infrared (IR) transceiver 66, a Bluetooth™ (BT) transceiver 68 operating using Bluetooth™ brand wireless technology developed by the Bluetooth™ Special Interest Group, a wireless universal serial bus (USB) transceiver 70 and/or the like. The Bluetooth™ transceiver 68 may be capable of operating according to low power/energy or ultra-low power/energy Bluetooth™ technology (for example, Wibree™) radio standards. In this regard, the mobile terminal 10 and, in particular, the short-range transceiver may be capable of transmitting data to and/or receiving data from electronic devices within a proximity of the mobile terminal, such as within 10 meters, for example. The mobile terminal may be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like. Alternatively or additionally, the mobile terminal may comprise a CR.

The mobile terminal 10 may comprise memory, such as a removable or non-removable subscriber identity module (SIM) 38, a soft SIM 38, a fixed SIM 38, a removable or non-removable universal subscriber identity module (USIM) 38, a soft USIM 38, a fixed USIM 38, a removable user identity module (R-UIM), and/or the like, which may store information elements related to a mobile subscriber. In addition to the SIM, the mobile terminal may comprise other removable and/or fixed memory. The mobile terminal 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices (for example, hard disks, floppy disk drives, magnetic tape, etc.), optical disc drives and/or media, non-volatile random access memory (NVRAM), and/or the like. Like volatile memory 40 non-volatile memory 42 may comprise a cache area for temporary storage of data. The memories may store one or more software programs, instructions, pieces of information, data, and/or the like which may be used by the mobile terminal for performing functions of the mobile terminal. For example, the memories may comprise an identifier, such as an international mobile equipment identification (IMEI) code, capable of uniquely identifying the mobile terminal 10.

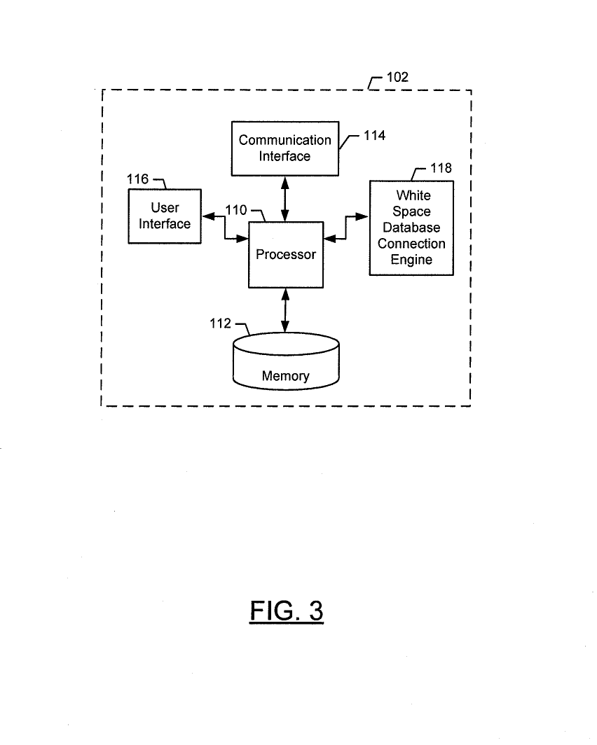

Referring now to FIG. 3, FIG. 3 illustrates a block diagram of a communication device 102 according to an example embodiment. In the example embodiment, the communication device 102 may comprise various means for performing the various functions herein described. These means may comprise one or more of a processor 110, memory 112, communication interface 114, user interface 116, and/or white space database connection engine 118. The means of the communication device 102 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example memory 112) that is executable by a suitably configured processing device (for example, the processor 110), or some combination thereof.

In some example embodiments, one or more of the means illustrated in FIG. 3 may be embodied as a chip or chip set. In other words, the communication device 102 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 110, memory 112, communication interface 114, user interface 116, and/or white space database connection engine 118 may be embodied as a chip or chip set. The communication device 102 may therefore, in some example embodiments, be configured to implement embodiments of the present invention on a single chip or as a single “system on a chip.” As another example, in some example embodiments, the communication device 102 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 110 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other hardware processors, or some combination thereof. Accordingly, although illustrated in FIG. 3 as a single processor, in some embodiments the processor 110 may comprise a plurality of processors. The plurality of processors may be in operative communication with each other and may be collectively configured to perform one or more functionalities of the communication device 102 as described herein. The plurality of processors may be embodied on a single computing device or distributed across a plurality of computing devices collectively configured to function as the communication device 102. In embodiments wherein the communication device 102 is embodied as a mobile terminal 10, the processor 110 may be embodied as or comprise the processor 20. In some example embodiments, the processor 110 is configured to execute instructions stored in the memory 112 or otherwise accessible to the processor 110. These instructions, when executed by the processor 110, may cause the communication device 102 to perform one or more of the functionalities of the communication device 102 as described herein. As such, whether configured by hardware or software methods, or by a combination thereof, the processor 110 may comprise an entity capable of performing operations according to embodiments of the present invention while configured accordingly. Thus, for example, when the processor 110 is embodied as an ASIC, FPGA or the like, the processor 110 may comprise specifically configured hardware for conducting one or more operations described herein. Alternatively, as another example, when the processor 110 is embodied as an executor of instructions, such as may be stored in the memory 112, the instructions may specifically configure the processor 110 to perform one or more algorithms and operations described herein.

The memory 112 may comprise, for example, volatile memory, non-volatile memory, or some combination thereof. In this regard, the memory 112 may comprise one or more tangible and/or non-transitory computer-readable storage media that may include volatile and/or non-volatile memory. Although illustrated in FIG. 3 as a single memory, the memory 112 may comprise a plurality of memories. The plurality of memories may be embodied on a single computing device or may be distributed across a plurality of computing devices collectively configured to function as the communication device 102. In various example embodiments, the memory 112 may comprise a hard disk, random access memory, cache memory, flash memory, a compact disc read only memory (CD-ROM), digital versatile disc read only memory (DVD-ROM), an optical disc, circuitry configured to store information, or some combination thereof. In embodiments wherein the communication device 102 is embodied as a mobile terminal 10, the memory 112 may comprise the volatile memory 40 and/or the non-volatile memory 42. The memory 112 may be configured to store information, data, applications, instructions, or the like for enabling the communication device 102 to carry out various functions in accordance with various example embodiments. For example, in some example embodiments, the memory 112 is configured to buffer input data for processing by the processor 110. Additionally or alternatively, the memory 112 may be configured to store program instructions for execution by the processor 110. The memory 112 may store information in the form of static and/or dynamic information. This stored information may be stored and/or used by the white space database connection engine 118 during the course of performing its functionalities, such as by accessing stored authenticated white space database contact information.

The communication interface 114 may be embodied as any device or means embodied in circuitry, hardware, a computer program product comprising computer readable program instructions stored on a computer readable medium (for example, the memory 112) and executed by a processing device (for example, the processor 110), or a combination thereof that is configured to receive and/or transmit data from/to another computing device. In an example embodiment, the communication interface 114 may be at least partially embodied as or otherwise controlled by the processor 110. In this regard, the communication interface 114 may be in communication with the processor 110, such as via a bus. The communication interface 114 may include, for example, an antenna, a transmitter, a receiver, a transceiver and/or supporting hardware or software for enabling communications with one or more remote computing devices. The communication interface 114 may be configured to receive and/or transmit data using any protocol that may be used for communications between computing devices, such as for example, an open mobile alliance (OMA) device management interface, a simple object access protocol (SOAP) extensible markup language (XML) interface or a client provisioning interface. In this regard, the communication interface 114 may be configured to receive and/or transmit data using any protocol that may be used for transmission of data over a wireless network, wireline network, some combination thereof, or the like by which the communication device 102 and one or more computing devices or computing resources may be in communication. As an example, the communication interface 114 may be configured to enable communication between the communication device 102 and another device, such as another communication device 102. As a further example, the communication interface 114 may be configured to enable communication with an white space database discovery server 104 via the network 108. The communication interface 114 may additionally be in communication with the memory 112, user interface 116, and/or white space database connection engine 118, such as via a bus.

The user interface 116 may be in communication with the processor 110 to receive an indication of a user input and/or to provide an audible, visual, mechanical, or other output to a user. As such, the user interface 116 may include, for example, a keyboard, a mouse, a trackball, a display, a touch screen display, a microphone, a speaker, and/or other input/output mechanisms. In embodiments wherein the user interface 116 comprises a touch screen display, the user interface 116 may additionally be configured to detect and/or receive indication of a touch gesture or other input to the touch screen display. The user interface 116 may be in communication with the memory 112, communication interface 114, and/or white space database connection engine 118, such as via a bus.

The white space database connection engine 118 may be embodied as various means, such as circuitry, hardware, a computer program product comprising computer readable program instructions stored on a computer readable medium (for example, the memory 112) and executed by a processing device (for example, the processor 110), or some combination thereof and, in some embodiments, is embodied as or otherwise controlled by the processor 110. In embodiments wherein the white space database connection engine 118 is embodied separately from the processor 110, the white space database connection engine 118 may be in communication with the processor 110. The white space database connection engine 118 may further be in communication with one or more of the memory 112, communication interface 114, or user interface 116, such as via a bus.

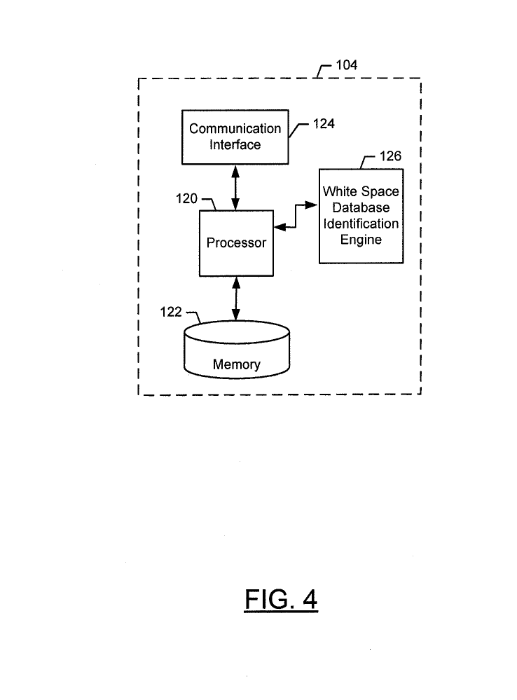

Referring now to FIG. 4, FIG. 4 illustrates a block diagram of an example white space database discovery server 104 according to an example embodiment. In an example embodiment, the white space database discovery server 104 may comprise various means for performing the various functions herein described. These means may comprise one or more of a processor 120, memory 122, communication interface 124, or white space database identification engine 126. The means of the white space database discovery server 104 as described herein may be embodied as, for example, circuitry, hardware elements (for example, a suitably programmed processor, combinational logic circuit, and/or the like), a computer program product comprising computer-readable program instructions (for example, software or firmware) stored on a computer-readable medium (for example, memory 122) that is executable by a suitably configured processing device (for example, the processor 120), or some combination thereof. Alternatively or additionally, FIG. 4 may illustrate and example white space database, such as white space database 106.

In some example embodiments, one or more of the means illustrated in FIG. 4 may be embodied as a chip or chip set. In other words, the white space database discovery server 104 may comprise one or more physical packages (for example, chips) including materials, components and/or wires on a structural assembly (for example, a baseboard). The structural assembly may provide physical strength, conservation of size, and/or limitation of electrical interaction for component circuitry included thereon. In this regard, the processor 120, memory 122, communication interface 124, and/or white space database identification engine 126 may be embodied as a chip or chip set. The white space database discovery server 104 may therefore, in some example embodiments, be configured to implement embodiments of the present invention on a single chip or as a single “system on a chip.” As another example, in some example embodiments, the white space database discovery server 104 may comprise component(s) configured to implement embodiments of the present invention on a single chip or as a single “system on a chip.” As such, in some cases, a chip or chipset may constitute means for performing one or more operations for providing the functionalities described herein and/or for enabling user interface navigation with respect to the functionalities and/or services described herein.

The processor 120 may, for example, be embodied as various means including one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits such as, for example, an ASIC (application specific integrated circuit) or FPGA (field programmable gate array), one or more other hardware processors, or some combination thereof. Accordingly, although illustrated in FIG. 4 as a single processor, in some embodiments the processor 120 may comprise a plurality of processors. The plurality of processors may be in operative communication with each other and may be collectively configured to perform one or more functionalities of the white space database discovery server 104 as described herein. The plurality of processors may be embodied on a single computing device or distributed across a plurality of computing devices collectively configured to function as the white space database discovery server 104. In some example embodiments, the processor 120 may be configured to execute instructions stored in the memory 122 or otherwise accessible to the processor 120. These instructions, when executed by the processor 120, may cause the white space database discovery server 104 to perform one or more of the functionalities of the white space database discovery server 104 as described herein. As such, whether configured by hardware or software methods, or by a combination thereof, the processor 120 may comprise an entity capable of performing operations according to embodiments of the present invention while configured accordingly. Thus, for example, when the processor 120 is embodied as an ASIC, FPGA or the like, the processor 120 may comprise specifically configured hardware for conducting one or more operations described herein. Alternatively, as another example, when the processor 120 is embodied as an executor of instructions, such as may be stored in the memory 122, the instructions may specifically configure the processor 120 to perform one or more algorithms and operations described herein.

The memory 122 may comprise, for example, volatile memory, non-volatile memory, or some combination thereof. In this regard, the memory 122 may comprise a non-transitory computer-readable storage medium. Although illustrated in FIG. 4 as a single memory, the memory 122 may comprise a plurality of memories. The plurality of memories may be embodied on a single computing device or may be distributed across a plurality of computing devices collectively configured to function as the white space database discovery server 104. In various example embodiments, the memory 122 may comprise a hard disk, random access memory, cache memory, flash memory, a compact disc read only memory (CD-ROM), digital versatile disc read only memory (DVD-ROM), an optical disc, circuitry configured to store information, or some combination thereof. The memory 122 may be configured to store information, data, applications, instructions, or the like for enabling the white space database discovery server 104 to carry out various functions in accordance with various example embodiments. For example, in some example embodiments, the memory 122 may be configured to buffer input data for processing by the processor 120. Additionally or alternatively, the memory 122 may be configured to store program instructions for execution by the processor 120. The memory 122 may store information in the form of static and/or dynamic information. This stored information may be stored and/or used by the white space database identification engine 126 during the course of performing its functionalities.

The communication interface 124 may be embodied as any device or means embodied in circuitry, hardware, a computer program product comprising computer readable program instructions stored on a computer readable medium (for example, the memory 122) and executed by a processing device (for example, the processor 120), or a combination thereof that is configured to receive and/or transmit data from/to another computing device. In an example embodiment, the communication interface 124 may be at least partially embodied as or otherwise controlled by the processor 120. In this regard, the communication interface 124 may be in communication with the processor 120, such as via a bus. The communication interface 124 may include, for example, an antenna, a transmitter, a receiver, a transceiver and/or supporting hardware or software for enabling communications with one or more remote computing devices. The communication interface 124 may be configured to receive and/or transmit data using any protocol that may be used for communications between computing devices. In this regard, the communication interface 124 may be configured to receive and/or transmit data using any protocol that may be used for transmission of data over a wireless network, wireline network, some combination thereof, or the like by which the white space database discovery server 104 and one or more computing devices or computing resources may be in communication. As an example, the communication interface 124 may be configured to enable communication with a communication device 102 by the network 108, a radio uplink, and/or the like. The communication interface 124 may additionally be in communication with the memory 122, and/or white space database identification engine 126, such as via a bus.

The white space database identification engine 126 may be embodied as various means, such as circuitry, hardware, a computer program product comprising computer readable program instructions stored on a computer readable medium (for example, the memory 122) and executed by a processing device (for example, the processor 120), or some combination thereof and, in some embodiments, is embodied as or otherwise controlled by the processor 120. In embodiments wherein the white space database identification engine 126 may be embodied separately from the processor 120, the white space database identification engine 126 may be in communication with the processor 120. The white space database identification engine 126 may further be in communication with one or more of the memory 122 or communication interface 124, such as via a bus.

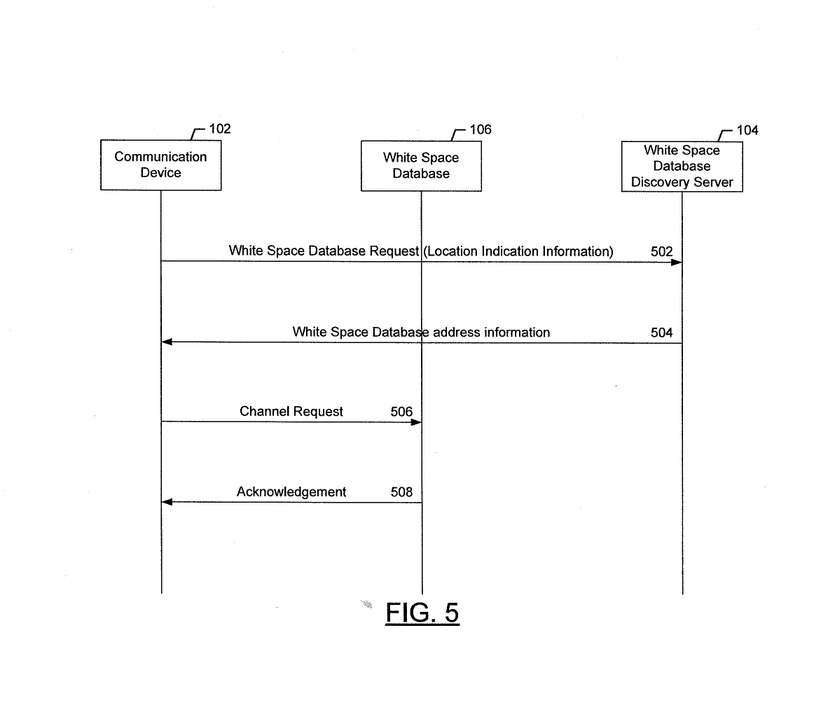

FIG. 5 illustrates a signal flow diagram according to example embodiments described herein. In some example embodiments, the white space database connection engine 118 may be configured to obtain information for establishing a connection with a white space database in order to communicate on a white space or regulated frequency band. The white space database connection engine 118 is therefore configured to, with the processor 110, the communication interface 114 or the like, to determine location indication information for the communication device 102. The location indication information, as described herein, includes but is not limited to a GPS measurement, longitude/latitude, mapping coordinates, a cellular measurement, a WiFi measurement, SSID, MNC/MCC or the like. The white space database connection engine 118 may therefore cause the location indication information to be transmitted to the white space database discovery server 104 such as via the communication interface 114. See for example, signal 502. Other information such as communication device capabilities, requested services, account information, a device identification, a serial number of the communication device, an identity token or the like may also be transmitted to the white space database discovery server 104. As is described herein, such communications between the communication device 102 and the white space database discovery server 104 may occur via network 108, via a packet based communication channel or via a circuit switched communication channel.

Upon receipt of the location indication information via communication interface 124, the white space database discovery server 104, such as by the processor 120, the white space database identification engine 126 or the like, may determine one or more white space databases that are authorized by the regulatory body for operation in the region (for example, based on the location indication information) in which the communication device 102 is currently located. Alternatively or additionally, the white space database discovery server 104, such as by the processor 120, the communication interface 124, the white space database identification engine 126 or the like, may determine one or more white space databases or identifiers to provide to the communication device 102 based on the communication device capabilities, requested services, account information, a device identification, a serial number of the communication device, an identity token or the like. The white space database discovery server 104, such as by the processor 120, the communication interface 124, the white space database identification engine 126 or the like may then be configured to cause an identifier (for example, URL or FQDN) and contact method (direct, indirect, protocol, schema or the like) for the one or more white space databases 106 to be transmitted to the communication device 102. See for example, signal 504.

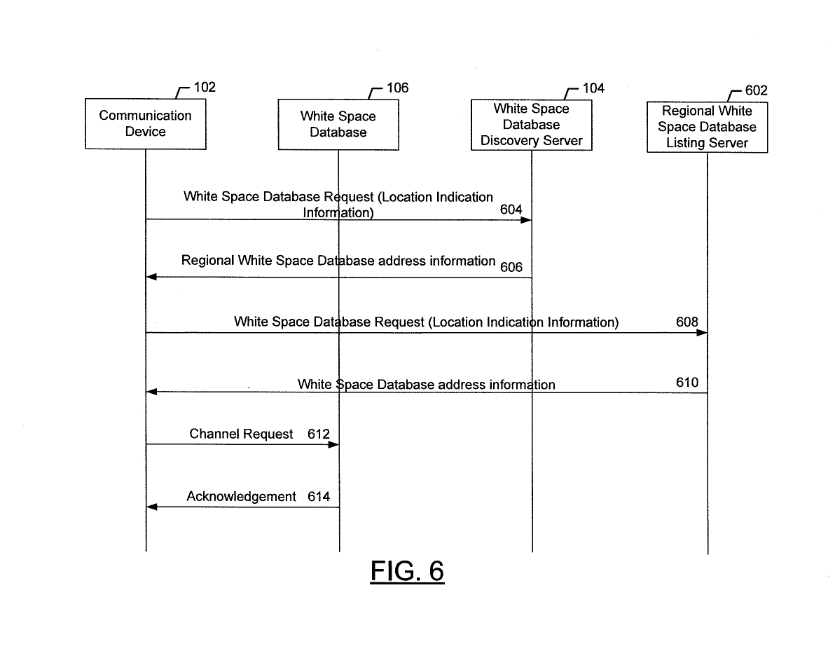

As is described herein, a direct method of contact includes an identifier for a white space database that may be used by a communication device to contact the white space database directly. Whereas an indirect method of contact includes an identifier for another server or database that may ultimately provide an identifier for a white space database or may act as an intermediary between the communication device and a white space database. See for example, FIG. 6.

Once the identifier and address information are received, the communication device 102 may cause a channel request to be transmitted, such as by the processor 110, the communications interface 114, the white space database connection engine 118 or the like, to a white space database 106. See for example, signal 506. As is described herein, the white space database 106 may be representative of any one of white space database 106a-n as are described with reference to FIG. 1. In some example embodiments, the communications device 102 may receive multiple white space database identifiers from the white space database discovery server 104. In such cases, the communications device 102, such as via the processor 110, the white space database connection engine 118 or the like, may select a white space database 106, based on services provided, connection protocol, contact method, cost, efficiency or the like.

In response to the transmitted channel request, the communication device 102 receives a regulated frequency band channel on which it may operate and an acknowledgement. See for example, signal 508. In instances in which a channel is not received from the white space database 106, such as because there not any channels available, the white space database 106 is unresponsive or the like, then the communications device 102 may cause a channel request to be transmitted to another white space database 106.

FIG. 6 illustrates a signal flow diagram of an example indirect method of contact according to example embodiments described herein. The communication device 102, such as by the white space database connection engine 118, may cause location indication information to be transmitted to the white space database discovery server 104 such as via the communication interface 114. See for example, signal 604. Upon receipt of the location indication information via communication interface 124, the white space database discovery server 104, such as by the processor 120, the white space database identification engine 126 or the like, may determine an identifier and contact method for the one or more white space databases 106 and cause the identifier and contact method to be transmitted to the communication device 102. See for example, signal 606.

In an instance in which the contact method provided by the white space database discovery server 104 is a direct method of contact, then the communication device 102 may cause a channel request to be transmitted to the white space database 106 and then may receive an acknowledgement. See for example, signals 612 and 614. Otherwise, in an instance in which the mode of contact is an indirect method of contact, then the communications device 102 receives an identifier for another server or database that may ultimately provide an identifier for a white space database 106 or may act as an intermediary between the communication device 102 and the white space database 106. In one indirect method of contact example, a regional white space discovery server 602 identifier may be provided.

The communication device 102, such as by the white space database connection engine 118, may cause location indication information to be transmitted to the regional white space listing server 602 such as via the communication interface 114. See for example, signal 608. Upon receipt of the location indication information via communication interface 124, the regional white space database listing server 602, may determine an identifier for the one or more white space databases 106 and cause the identifier to be transmitted to the communication device 102. See for example, signal 610. Alternatively or additionally, the regional white space database listing server 602 may function as an intermediary between the communication device 102 and the white space database 106.

Once the identifier is received, the communication device 102 may cause a channel request to be transmitted, such as by the processor 110, the communications interface 114, the white space database connection engine 118 or the like, to a white space database 106. See for example, signal 612. In response to the transmitted channel request, the communication device may receive a regulated frequency band channel on which it may operate and an acknowledgement. See for example, signal 614.

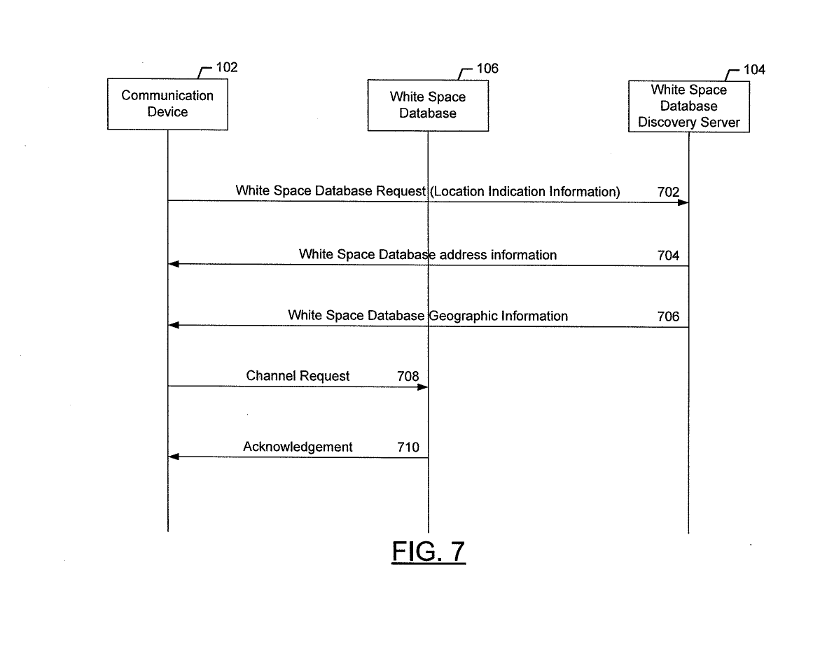

FIG. 7 illustrates a signal flow diagram of an example transmission of a geographic region defining an area in which a white space database identifier is valid according to an example embodiment described herein. The communication device 102, such as by the communication interface 114, the white space database connection engine 118 or the like, may cause location indication information to be transmitted to the white space database discovery server 104. See for example, signal 702. Upon receipt of the location indication information via communication interface 124, the white space database discovery server 104, such as by the processor 120, the white space database identification engine 126 or the like, may determine an identifier and contact method for the one or more white space databases 106 and cause the identifier and contact method to be transmitted to the communication device 102. See for example, signal 704.

The white space database discovery server 104, such as by the processor 120, the white space database identification engine 126 or the like, may also cause a geographic region (for example, polygon defined by points, point and radius and/or the like) to be transmitted that defines the region in which the identifier and contact method are valid for use. See for example, Signal 706. The communication device 102, may maintain a table, such as in the memory 112, that contains a mapping of a geographic region to database identifier for future use.

Once the identifier and address information are received, the communication device 102 may cause a channel request to be transmitted, such as by the processor 110, the communications interface 114, the white space database connection engine 118 or the like, to a white space database 106. See for example, signal 708. In response to the transmitted channel request, the communication device 102 may receive a regulated frequency band channel on which it may operate and an acknowledgement. See for example, signal 710.

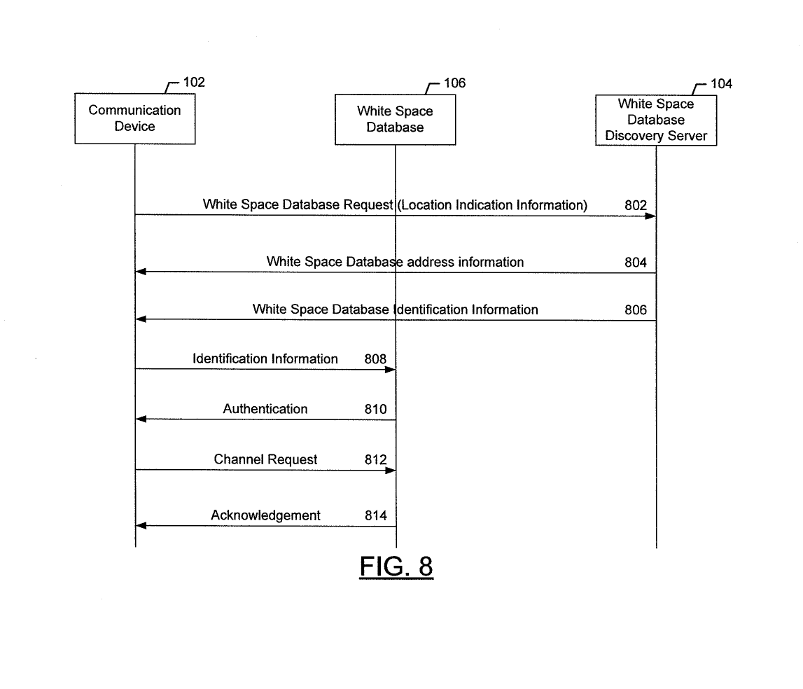

FIG. 8 illustrates a signal flow diagram of an example identification method according to an example embodiment described herein. The communication device 102, such as by the communication interface 114, the white space database connection engine 118 or the like, may cause location indication information to be transmitted to the white space database discovery server 104. See for example, signal 802. Upon receipt of the location indication information via communication interface 124, the white space database discovery server 104, such as by the processor 120, the white space database identification engine 126 or the like, may determine an identifier and contact method for the one or more white space databases 106 and cause the identifier and contact method to be transmitted to the communication device 102. See for example, signal 804.

The white space database discovery server 104, such as by the processor 120, the white space database identification engine 126 or the like, may cause an identification method (for example, public-key infrastructure (PKI) public certificate) to be transmitted. See for example, signal 806. The communication device 102 may then store, such as in the memory 112, the identification method and cause it to be transmitted, such as via the communication interface 114, to the white space database 106 to create an associated trust relationship where the white space database is caused to trust, on behalf of the communication device 102, the certificate owner, for example the white space database discovery server 104. See for example, signal 808. The trust relationship may, for example permit value added services to be provided by an external entity, for example the white space database 106. In response the communication device 102 may receive a response indicating authentication was successful. See for example, signal 810.

Once the identifier and address information are received, the communication device 102 may cause a channel request to be transmitted, such as by the processor 110, the communications interface 114, the white space database connection engine 118 or the like, to a white space database 106. See for example, signal 812. In response to the transmitted channel request, the communication device 106 may receive a regulated frequency band channel on which it may operate and an acknowledgement. See for example, signal 814.

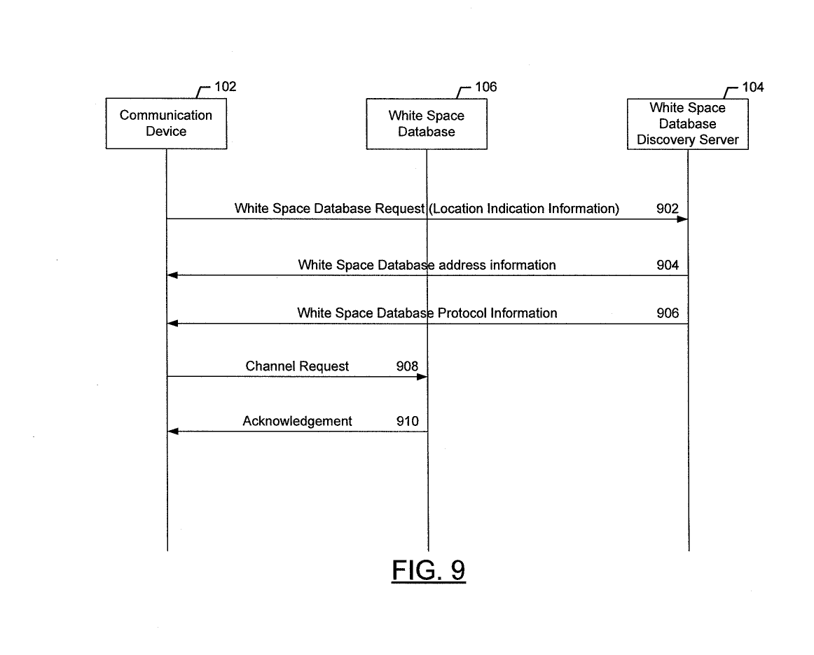

FIG. 9 illustrates a signal flow diagram of an example transmission of white space database protocol information according to an example embodiment described herein. The communication device 102, such as by the white space database connection engine 118, may cause location indication information to be transmitted to the white space database discovery server 104 such as via the communication interface 114. See for example, signal 902. Upon receipt of the location indication information via communication interface 124, the white space database discovery server 104, such as by the processor 120, the white space database identification engine 126 or the like, may determine an identifier and contact method for the one or more white space databases 106 and cause the identifier and contact method to be transmitted to the communication device 102. See for example, signal 904.

The white space database discovery server 104, such as by the processor 120, the white space database identification engine 126 or the like, may also transmit an indication of a protocol, such as a version of the PAWS protocol used to communicate with the white space database. See for example, signal 906. Once the identifier and address information are received, the communication device 102 may cause a channel request to be transmitted, such as by the processor 110, the communications interface 114, the white space database connection engine 118 or the like, to a white space database 106. See for example, signal 908. In response to the transmitted channel request, the communication device 102 may receive a regulated frequency band channel on which it may operate and an acknowledgement. See for example, signal 910.

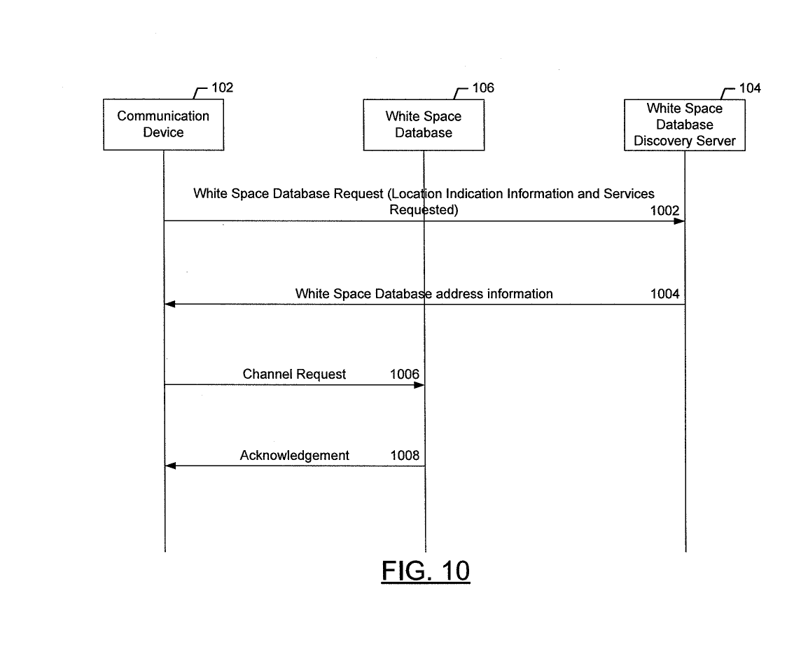

FIG. 10 illustrates a signal flow diagram of an example request for services according to an example embodiment described herein. The communication device 102, such as by the communication interface 114, the white space database connection engine 118 or the like, may cause location indication information and services requested to be transmitted to the white space database discovery server 104. See for example, signal 1002. Example services that may be requested by the communication device 102 include, but are not limited to, coexistence assistance, location based information delivery or spectrum brokerage. When more than one white space database is available for the communication device 102 to use, the white space database discovery server 104, may determine, such as by the processor 120, the white space database identification engine 126 or the like, a resulting list of white space database identifiers to be delivered to the communications device 102 such that white space databases which provide the requested service(s) are preferred over those that do not. The white space database identification engine 126 or the like, may cause an identifier and contact method for the determined one or more white space databases 106 that provide the requested services to be transmitted to the communication device 102. See for example, signal 1004.

Once the identifier and address information are received, the communication device 102 may cause a channel request to be transmitted, such as by the processor 110, the communications interface 114, the white space database connection engine 118 or the like, to a white space database 106. See for example, signal 1006. In response to the transmitted channel request, the communication device may receive a regulated frequency band channel on which it may operate and an acknowledgement. See for example, signal 1008.

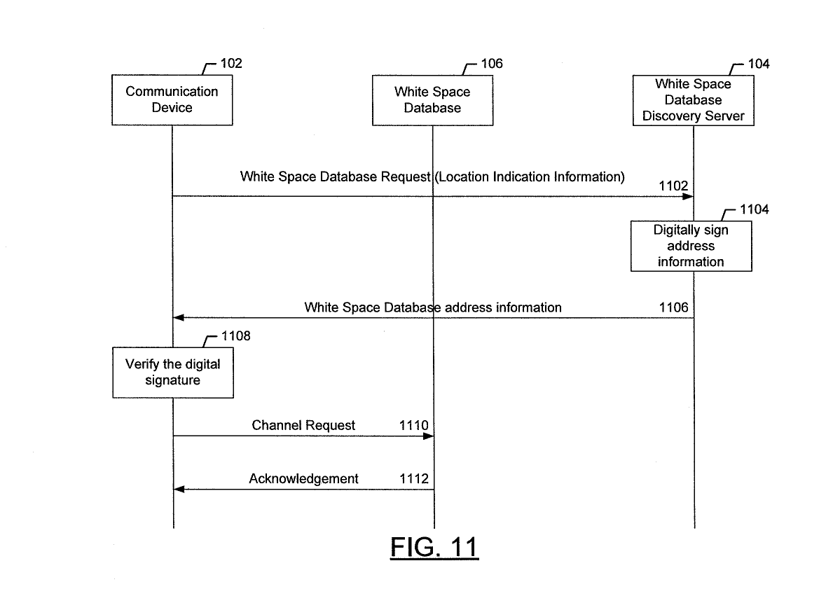

FIG. 11 illustrates a signal flow diagram of an example transmission signed with a digital signature according to an example embodiment described herein. The communication device 102, such as by the communication interface 114, the white space database connection engine 118 or the like, may cause location indication information to be transmitted to the white space database discovery server 104. See for example, signal 1102. Upon receipt of the location indication information via communication interface 124, the white space database discovery server 104, such as by the processor 120, the white space database identification engine 126 or the like, may determine an identifier and contact method for the one or more white space databases 106 and cause the identifier and contact method to be transmitted to the communication device 102. See for example, signal 1106. As is shown in operation 1104, the white space database discovery server 104, such as by the processor 120 may cause the transmission in signal 1006 to be digitally signed.

The communications device 102 may verify the digital signature in operation 1108 such as by the processor 110. As such, the communications device 102 is configured to determine, based on a valid digital signature, that the received identifier is authenticated. Once the identifier and address information are received and are authenticated in operation 1108, the communication device 102 may cause a channel request to be transmitted, such as by the processor 110, the communications interface 114, the white space database connection engine 118 or the like, to a white space database 106. See for example, signal 1110. In response to the transmitted channel request, the communication device may receive a regulated frequency band channel on which it may operate and an acknowledgement. See for example, signal 1112.

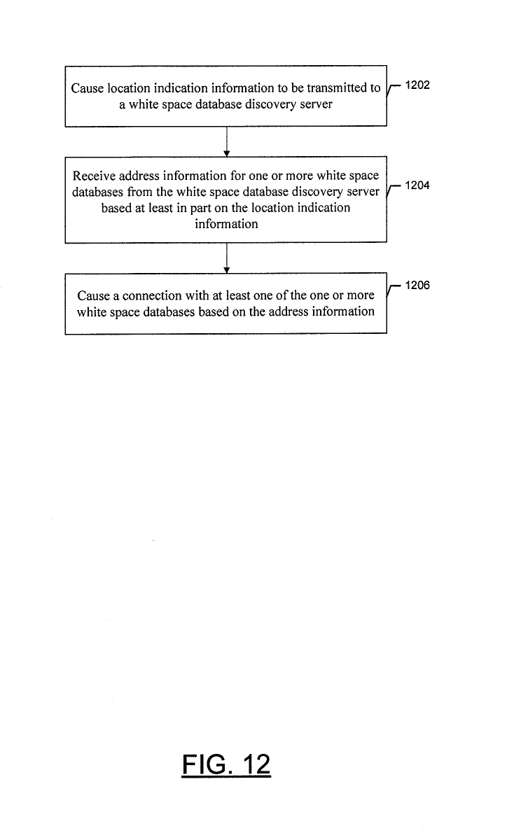

FIG. 12 illustrates a flowchart according to an example method configured to be executed by a communication device according to some example embodiments of the current invention. As shown in operation 1202, the communication device 102 may include means, such as the processor 110, the communication interface 114, the white space database connection engine 118, or the like, for causing location indication information to be transmitted to a white space database discovery server. As shown in operation 1204, the communication device 102 may include means, such as the processor 110, the communication interface 114, the white space database connection engine 118, or the like, for receiving address information (for example, URL, FQDN or the like) for one or more white space databases from the white space database discovery server based at least in part on the location indication information. As shown in operation 1206, the communication device 102 may include means, such as the processor 110, the communication interface 114, the white space database connection engine 118, or the like, for causing a connection with at least one of the one or more white space databases based on the address information.

Alternatively or additionally, the communication device 102 may include means, such as the processor 110, the communication interface 114, the white space database connection engine 118, or the like, for receiving a geographic region in which the identifier for the one or more white space databases is valid for use. In some example embodiments, the geographic region in which the identifier for the one or more white space databases is valid for use is stored in a table, such as in the memory 112.

Alternatively or additionally, the communication device 102 may include means, such as the processor 110, the communication interface 114, the white space database connection engine 118, or the like, for receiving address information for a regional white space database listing server based at least in part on the location indication information in an instance in which the contact method is determined to be an indirect contact method. The communication device 102 may further cause a connection with at least one of the one or more white space databases based on address information received from the regional white space database listing server.

Alternatively or additionally, the communication device 102 may include means, such as the processor 110, the communication interface 114, the white space database connection engine 118, or the like, for causing a received security certificate to be transmitted to the at least one of the one or more white space databases in order to establish a trust relationship on behalf of the communication device between the certificate owner and at least one of the one or more white space databases.

Alternatively or additionally, the communication device 102 may include means, such as the processor 110, the communication interface 114, the white space database connection engine 118, or the like, for receiving an indication of a communications protocol for communication with the one or more white space databases received from the white space database discovery server. Alternatively or additionally, the communication device 102 may include means, such as the processor 110, the communication interface 114, the white space database connection engine 118, or the like, for receiving address information for one or more white space databases from the white space database discovery server based on one or more previously requested services. In some example embodiments, the one or more white space databases are configured to provide the one or more services requested.

Alternatively or additionally, the communication device 102 may include means, such as the processor 110, the communication interface 114, the white space database connection engine 118, or the like, for determining that the received address information for one or more white space databases from the white space database discovery server is digitally signed. In some example embodiments, the digital signature may indicate that the one or more white space databases are authorized white space databases.

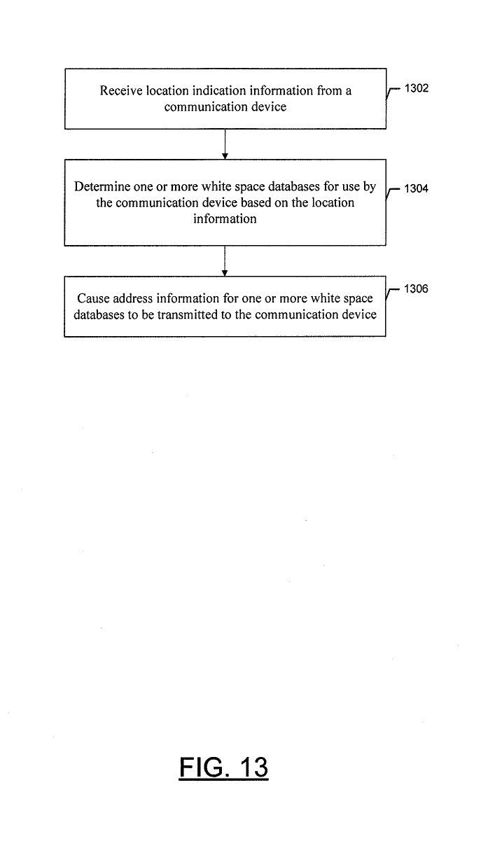

FIG. 13 illustrates a flowchart according to an example method configured to be executed by a white space database discovery server according to some example embodiments of the current invention. As shown in operation 1302, the white space database discovery server 104 may include means, such as the processor 120, the communication interface 124, the white space database identification engine 126, or the like, for receiving location indication information from a communication device. As shown in operation 1304, the white space database discovery server 104 may include means, such as the processor 120, the white space database identification engine 126, or the like, for determining one or more white space databases for use by the communication device based on the location information. As shown in operation 1306, the white space database discovery server 104 may include means, such as the processor 120, the communication interface 124, the white space database identification engine 126, or the like, for causing address information for one or more white space databases to be transmitted to the communication device.

Alternatively or additionally, the white space database discovery server 104 may include means, such as the processor 120, the white space database identification engine 126, or the like, for determining a geographic region in which the identifier and contact method for the one or more white space databases is valid for use. In some example embodiments, the geographic region may be transmitted to the communication device.

Alternatively or additionally, the white space database discovery server 104 may include means, such as the processor 120, the communication interface 124, the white space database identification engine 126, or the like, for causing address information for a regional white space database listing server to be transmitted to the communications device in which the contact method is an indirect contact method. In some example embodiments, the communication device is configured to contact the regional white space discovery server to determine address information for one of the one or more white space databases.

Alternatively or additionally, the white space database discovery server 104 may include means, such as the processor 120, the communication interface 124, the white space database identification engine 126, or the like, for causing a security certificate to be transmitted to the communication device, wherein the security certificate is configured to notify the one or more white space databases of a trust relationship. Alternatively or additionally, the white space database discovery server 104 may include means, such as the processor 120, the communication interface 124, the white space database identification engine 126, or the like, for causing an indication of a communications protocol for communication with the one or more white space databases to be transmitted to the communication device.

Alternatively or additionally, the white space database discovery server 104 may include means, such as the processor 120, the communication interface 124, the white space database identification engine 126, or the like, for receiving an indication of one or more services requested from the communication device and determining one or more capabilities of the communication device. The white space database discovery server 104 may be configured, such as the processor 120, the white space database identification engine 126, or the like, to determine address information for one or more white space databases. In some example embodiments, the one or more white space databases are configured to provide the one or more services requested based on the one or more capabilities of the communication device.

FIGS. 12 and 13 illustrate example flowcharts of a system, method, and computer program product according to example embodiments of the invention. It will be understood that each block of the flowchart, and combinations of blocks in the flowchart, may be implemented by various means, such as hardware and/or a computer program product comprising one or more computer-readable mediums (as opposed to a computer-readable transmission medium which describes a propagating signal) having one or more computer program code instructions, program instructions, or executable computer-readable program code instructions stored therein. For example, one or more of the procedures described herein may be embodied by computer program instructions of a computer program product. In this regard, the computer program product(s) that embodies the procedures described herein may be stored by one or more memory devices (for example, memory 112, memory 122, volatile memory 40, or non-volatile memory 42) of a mobile terminal, server, or other computing device (for example, the communication device 102, white space database discovery server 104) and executed by a processor (for example, the processor 110, the processor 120 or processor 20) in the computing device. In some embodiments, the computer program instructions comprising the computer program product(s) that embodies the procedures described above may be stored by memory devices of a plurality of computing devices. As will be appreciated, any such computer program product may be loaded onto a computer or other programmable apparatus to produce a machine, such that the computer program product including the instructions which execute on the computer or other programmable apparatus creates means for implementing the functions specified in the flowcharts' block(s).

Further, the computer program product may comprise one or more computer-readable memories on which the computer program instructions may be stored such that the one or more computer-readable memories can direct a computer or other programmable apparatus to function in a particular manner, such that the computer program product may comprise an article of manufacture which implements the function specified in the flowcharts' block(s). The computer program instructions of one or more computer program products may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowcharts' block(s). Retrieval, loading, and execution of the program code instructions may be performed sequentially such that one instruction is retrieved, loaded, and executed at a time. In some example embodiments, retrieval, loading and/or execution may be performed in parallel such that multiple instructions are retrieved, loaded, and/or executed together.

Accordingly, execution of instructions associated with the operations of the flowchart by a processor, or storage of instructions associated with the blocks or operations of the flowchart in a computer-readable storage medium, support combinations of operations for performing the specified functions. It will also be understood that one or more operations of the flowchart, and combinations of blocks or operations in the flowchart, may be implemented by special purpose hardware-based computer systems and/or processors which perform the specified functions, or combinations of special purpose hardware and program code instructions.

The above described functions may be carried out in many ways. For example, any suitable means for carrying out each of the functions described above may be employed to carry out embodiments of the invention. In example embodiments, a suitably configured processor (for example, the processor 110 and/or processor 120) may provide all or a portion of the elements of the invention. In other embodiments, all or a portion of the elements of the invention may be configured by and operate under control of a computer program product. The computer program product for performing the methods of embodiments of the invention may comprise a computer-readable storage medium, such as the non-volatile storage medium (for example, the memory 112 and/or memory 122), and computer-readable program code portions, such as a series of computer instructions, embodied in the computer-readable storage medium.

In some example embodiments, the white space database discovery server may be operated by the same vendor that manufactures the communications device. Thus the vendor may confirm to a communication device that only authorized database are provided by digitally signing a response. In response, the communication device may verify the digital signature to ensure that the communication device has requested service from a white space database that is authorized by regulatory body.

The systems and methods as disclosed herein are configured, for example, to enable a mobile terminal to roam into any regulatory domain where use of white space spectrum has been approved by the local regulator, and dynamically operate within the regulatory bounds set by the regulator. For example, the mobile terminal may determine one or more white space databases that allows access to the white space spectrum in a particular domain.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
causing location indication information to be transmitted, using a communications network, -to a white space database discovery server, wherein the white space discovery server is remote and is configured to store address information for one or more white space databases;
receiving address information for the one or more white space databases from the white space database discovery server based at least in part on the location indication information; and
causing a connection with at least one of the one or more white space databases based on the address information, wherein at least one of the one or more white space databases are configured to provide a communication channel.

2. A method according to claim 1, wherein the location indication information is configured to provide information to the white space database discovery server to enable a determination of a current location, the location indication information comprising at least one of global positioning system information, a wireless network signal measurement, a service set identification, a cellular signal measurement or an access point identification.

3. A method according to claim 1, wherein the address information comprises at least one of an identifier and a contact method.

4. A method according to claim 3, wherein the identifier is at least one of a uniform resource locator or a fully qualified domain name.

5. A method according to claim 4, further comprises:
receiving a geographic region in which the identifier and the contact method for the one or more white space databases is valid for use; and
causing the geographic region in which the identifier for the one or more white space databases is valid for use to be stored in a table.

6. A method according to claim 3, wherein the contact method is at least one of a direct contact method or an indirect contact method.

7. A method according to claim 6, further comprising:
receiving address information for a regional white space database listing server based at least in part on the location indication information in an instance in which the contact method is determined to be an indirect contact method;
causing location indication information to be transmitted to the regional white space database listing server;
receiving address information for one or more white space databases from the regional white space database listing server; and
causing a connection with at least one of the one or more white space databases based on the address information.

8. A method according to claim 1, further comprising:
receiving a security certificate from the white space database discovery server, wherein the security certificate defines a trust relationship on behalf of the communication device;
causing the security certificate to be transmitted to the at least one of the one or more white space databases; and
receiving a notification of a trust relationship with the at least one of the one or more white space databases.

9. A method according to claim 1, wherein at least one of the transmission to the white space database discovery server or the one or more white space databases is transmitted via at least one of a packet based communication channel or a circuit switched communication channel.

10. A method according to claim 1, further comprising:
receiving an indication of a communications protocol for communication with the one or more white space databases received from the white space database discovery server.

11. A method according to claim 1, further comprising:
causing one or more services to be requested from a white space database discovery server; and
receiving address information for one or more white space databases from the white space database discovery server based on the one or more services requested, wherein the one or more white space databases are configured to provide the one or more services requested.

12. A method according to claim 1, further comprising:
determining that the received address information for one or more white space databases from the white space database discovery server is signed with a digital signature, wherein the digital signature indicates that the one or more white space databases are authorized white space databases.

13. An apparatus comprising:
at least one processor; and
at least one memory including computer program code, the at least one memory and the computer program code configured to, with the at least one processor, cause the apparatus to at least:
cause location indication information to be transmitted, using a communications network, -to a white space database discovery server, wherein the white space discovery server is remote from the apparatus and is configured to store address information for one or more white space databases;
receive address information for the one or more white space databases from the white space database discovery server based at least in part on the location indication information; and
cause a connection with at least one of the one or more white space databases based on the address information, wherein at least one of the one or more white space databases are configured to provide a communication channel.

14. An apparatus according to claim 13, wherein the location indication information is configured to provide information to the white space database discovery server to enable a determination of a current location, the location indication information comprising at least one of global positioning system information, a wireless network signal measurement, a service set identification, a cellular signal measurement or an access point identification.

15. An apparatus according to claim 13, wherein the address information comprises at least one of an identifier and a contact method.

16. An apparatus according to claim 15, wherein the identifier is at least one of a uniform resource locator or a fully qualified domain name.

17. An apparatus according to claim 16, wherein the at least one memory including the computer program code is further configured to, with the at least one processor, cause the apparatus to:
receive a geographic region in which the identifier and the contact method for the one or more white space databases is valid for use; and
cause the geographic region in which the identifier for the one or more white space databases is valid for use to be stored in a table.

18. An apparatus according to claim 15, wherein the contact method is at least one of a direct contact method or an indirect contact method.

19. An apparatus according to claim 18, wherein the at least one memory including the computer program code is further configured to, with the at least one processor, cause the apparatus to:
receive address information for a regional white space database listing server based at least in part on the location indication information in an instance in which the contact method is determined to be an indirect contact method;
cause location indication information to be transmitted to the regional white space database listing server;
receive address information for one or more white space databases from the regional white space database listing server; and
cause a connection with at least one of the one or more white space databases based on the address information.

20. An apparatus according to claim 13, wherein the at least one memory including the computer program code is further configured to, with the at least one processor, cause the apparatus to:
receive a security certificate from the white space database discovery server, wherein the security certificate defines a trust relationship on behalf of the communication device;
cause the security certificate to be transmitted to the at least one of the one or more white space databases; and
receive a notification of a trust relationship with the at least one of the one or more white space databases.

21. An apparatus according to claim 13, wherein at least one of the transmission to the white space database discovery server or the one or more white space databases is transmitted via at least one of a packet based communication channel or a circuit switched communication channel.

22. An apparatus according to claim 13, wherein the at least one memory including the computer program code is further configured to, with the at least one processor, cause the apparatus to:
receive an indication of a communications protocol for communication with the one or more white space databases received from the white space database discovery server.

23. An apparatus according to claim 13, wherein the at least one memory including the computer program code is further configured to, with the at least one processor, cause the apparatus to:
cause one or more services to be requested from a white space database discovery server; and
receive address information for one or more white space databases from the white space database discovery server based on the one or more services requested, wherein the one or more white space databases are configured to provide the one or more services requested.

24. An apparatus according to claim 13, wherein the at least one memory including the computer program code is further configured to, with the at least one processor, cause the apparatus to:
determine that the received address information for one or more white space databases from the white space database discovery server is signed with a digital signature, wherein the digital signature indicates that the one or more white space databases are authorized white space databases.

25. A method comprising:
receiving location indication information from a communication device;
determining one or more white space databases for use by the communication device based on the location indication information; and
causing address information for one or more white space databases to be transmitted to the communication device.

26. A method according to claim 25, wherein the location indication information enables a determination of a current location, the location indication information comprising at least one of global positioning system information, a wireless network signal measurement, a service set identification, a cellular signal measurement or an access point identification.

27. A method according to claim 25, wherein the address information comprises at least one of an identifier that includes at least one of a uniform resource locator or a fully qualified domain name and a contact method that includes at least one of a direct contact method or indirect contact method.

28. A method according to claim 27, further comprises:
determining a geographic region in which the identifier and contact method for the one or more white space databases is valid for use; and
causing the geographic region in which the identifier for the one or more white space databases are valid for use to be transmitted to the communication device.

29. A method according to claim 27, further comprising:
causing address information for a regional white space database listing server to be transmitted to the communication device in which the contact method is an indirect contact method, wherein the communication device is configured to contact the regional white space database listing server to determine address information for one of the one or more white space databases.

30. A method according to claim 25, further comprising:
causing a security certificate to be transmitted to the communication device, wherein the security certificate is configured to notify the one or more white space databases of a trust relationship on behalf of the communication device.

31. A method according to claim 25, further comprising:
causing an indication of a communications protocol for communication with the one or more white space databases to be transmitted to the communication device.

32. A method according to claim 25, further comprising:
receiving an indication of one or more services requested from the communication device;
determining one or more capabilities of the communication device; and
determining address information for one or more white space databases, wherein the one or more white space databases are configured to provide the one or more services requested based on the one or more capabilities of the communication device.
